(19) United States
(12) Patent Application Publication
(10) Pub. No.: US 2001/0010368 A1
(43) Pub. Date: Aug. 2, 2001

(54) Phosphor of red luminous color

(76) Inventors: Shigeo Itoh, Mobara-shi (JP); Hitoshi Toki, Mobara-shi (JP); Fumiaki Kataoka, Mobara-shi (JP); Vladimir Markovich, Yokohama-shi (JP)

Correspondence Address: BREINER & BREINER, 115 North Henry Street, P.O. Box 19290, Alexandria, VA, 22320-0290, US

(21) Appl. No.: 09/774,118

(22) Filed: Jan. 31, 2001

(30) Foreign Application Priority Data
Feb. 1, 2000 (JP) 2000-024145

(51) Int. Cl. C09K 11/54

(52) U.S. Cl. 252/301.6 R; 252/301.6 S

(57) ABSTRACT

A ZnO phosphor of a red luminous color capable of being increased in luminous efficiency. A the Zn_{3.5}Y_{0.92}Eu_{0.08}O₅ phosphor which is an example of the present invention is manufactured by immersing 117 mmol of ZnO:Zn in an aqueous solution in which 1.84 mmol of YCl₃ and 0.16 mmol of EuCl₃ are dissolved. Excessive water is vaporized by heating the solution to a temperature of 300° C. This results in pink porous blocks being obtained, which are then placed in a crucible. The crucible is heated at 100° C. for two hours, so that a white powder of a red luminous color is obtained. The powder has main peaks at 612 nm and 702 nm. A luminous spectra of the phosphor indicates that it exhibits enhanced luminous efficiency.

### BACKGROUND OF THE INVENTION

This invention relates to a phosphor material emitting light of a visible wavelength when it is excited under suitable conditions using an electron beam, and more particularly to a phosphor of a red luminous color improved in luminous characteristics, chromaticity and durability, resulting in being applied to manufacturing of a phosphor, a flat panel display and a cathode ray tube (CRT).

A luminous material or phosphor has been applied to manufacturing of a CRT including a display ,plane excited by an electron beam through many years. When an electron beam is impinged on a phosphor, it absorbs energy from the electron beam, to thereby re-emit the energy in the form of light having a wavelength within a visible range.

A ZnO:Zn phosphor of a bluish green luminous color has been conventionally known as a ZnO phosphor or a phosphor of which a matrix is constituted by ZnO. Also, a ZnO:M,S phosphor wherein M is metal selected from the group consisting of Lu, Hf, Ta and W is known as another ZnO phosphor, as disclosed in Japanese Patent Application Laid-Open Publication No. 163489/1993.

Unfortunately, the conventional ZnO phosphors do not include a phosphor of a red luminous phosphor.

### SUMMARY OF THE INVENTION

The present invention has been made in view of the foregoing disadvantage of the prior art.

Accordingly, it is an object of the present invention to provide a ZnO phosphor of a red luminous color which is increased in luminous efficiency and luminescence.

In accordance with the present invention, a phosphor of a red luminous color is provide. The phosphor includes ZnO, and Y and Eu for co-activating or jointly activating Y.

In a preferred embodiment of the present invention, Y has a concentration of 6 to 30% by weight and Eu has a concentration of 0.6 to 10% by weight.

In a preferred embodiment of the present invention, oxygen contained in ZnO is partially replaced with sulfur in an amount of 1.5% by weight.

### BRIEF DESCRIPTION OF THE DRAWINGS

These and other objects and many of the attendant advantages of the present invention will be readily appreciated as the same becomes better understood by reference to the following detailed description when considered in connection with the accompanying drawings; wherein:

FIG. 1 is a graphical representation showing luminous spectra of a Zn_{3.5}Y_{0.92}Eu_{0.08}O₅ phosphor which is an example of a phosphor according to the present invention.

### DETAILED DESCRIPTION OF THE PREFERRED EMBODIMENT

Now, a phosphor of the present invention will be described hereinafter in detail.

In accordance with the present invention, a phosphor of a red luminous color is provided which is improved in luminous efficiency and life or durability. Such an improved phosphor has not been known at all and is fully novel. Also, the inventors surprisingly found that it is highly effective to jointly activate or co-activate ZnO using yttrium (Y) in an amount of 6 to 30% by weight and europium (Eu) in an amount of 0.6 to 10% by weight. In other words, the inventors found that use of each of Y and Eu in an amount out of the above-described ranges fails to permit the phosphor of the present invention to exhibit practical luminous efficiency. Also, the phosphor of the present invention may contain sulfur (S) in an amount of 1.5% by weight as a minor component.

Thus, the ZnO phosphor of the present invention is obtained by co-activating ZnO with Y and Eu and exhibits enhanced luminous efficiency and luminescence.

The invention will be understood more readily with reference to the following examples; however, these examples are intended to illustrate the invention and are not construed to limit the scope of the invention.

### EXAMPLE 1

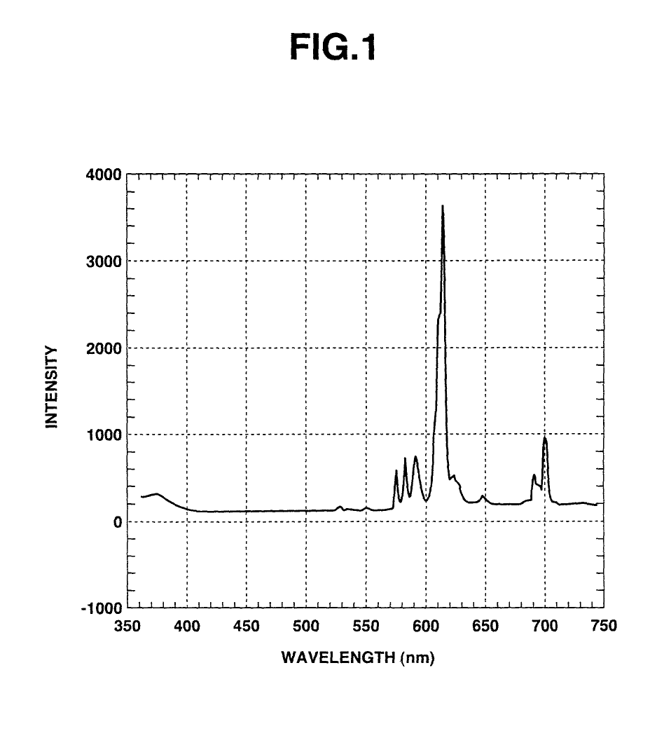

FIG. 1 shows luminous spectra of a Zn_{3.5}Y_{0.92}Eu_{0.08}O₅ phosphor which is an example of a phosphor according to the present invention. From FIG. 1, it will be noted that the phosphor of the present invention exhibits highly enhanced luminous intensity or efficiency. Now, manufacturing of the Zn_{3.5}Y_{.092}Eu_{0.08}O₅ phosphor will be described.

117 mmol of ZnO:Zn was immersed in an aqueous solution in which 1.84 mmol of YCl₃ and 0.16 mmol of EuCl₃ were dissolved. Excessive water was vaporized by heating the solution to a temperature of 300° C. This resulted in pink porous blocks being obtained, which were then placed in a crucible. The crucible was heated at 1000° C. for two (2) hours, so that a white powder of a red luminous color was obtained. The powder had main peaks at 612 nm and 702 nm.

### EXAMPLE 2

A Zn₄Y_{0.92}Eu_{0.08}O_{5.5} phosphor which is another example of a phosphor according to the present invention was manufactured as follows:

8 mmol of ZnO:Zn was immersed in an aqueous solution in which 1.94 mmol of YC1₃ and 0.06 mmol of EuCl₃ were dissolved. Excessive water was vaporized by heating the solution to a temperature of 300° C. This resulted in white porous blocks being obtained, which were then placed in a crucible. The crucible was heated at 1000° C. for three (3) hours, so that a white powder of a red luminous color was obtained. The powder had main peaks at 612 nm and 630 nm.

### EXAMPLE 3

A Zn_{3.5}Y_{1.95}Eu_{0.05}O_{6.18} phosphor which is a further example of a phosphor according to the present invention was manufactured as follows:

5 mmol of ZnO:Zn was immersed in an aqueous solution in which 1.95 mmol of YCl₃ and 0.05 mmol of EuCl₃ were dissolved. Excessive water was vaporized by heating the solution to a temperature of 300° C. This resulted in white porous blocks being obtained, which were then placed in a crucible. 0.32 mmol of sulfur (S) was added to the crucible. The crucible was heated at 1000° C. for three (3) hours, so that a white powder of a red luminous color was obtained. The powder had a main peak at 618 nm.

While a preferred embodiment of the invention has been described with a certain degree of particularity with reference to the drawings, obvious modifications and variations are possible in light of the above teachings. It is therefore to be understood that within the scope of the appended claims, the invention may be practiced otherwise than as specifically described.

What is claimed is:

1. A phosphor of a red luminous color, comprising:
ZnO; and
Y and Eu for co-activating said Y.

2. A phosphor as defined in claim 1, wherein Y has a concentration of 6 to 30% by weight and Eu has a concentration of 0.6 to 10% by weight.

3. A phosphor as defined in claim 1, wherein oxygen contained in ZnO is partially replaced with sulfur in an amount of 1.5% by weight.
